(19) United States
(12) Patent Application Publication
(10) Pub. No.: US 2014/0202932 A1
(43) Pub. Date: Jul. 24, 2014

(54) FLOTATION PROCESS AND FLOTATION APPARATUS FOR COAL FLYASH

(71) Applicant: Minqing Xu, Longyan City (CN)

(72) Inventor: Minqing Xu, Longyan City (CN)

(73) Assignee: Fujian Longyan Longneng Flyash Comprehensive Utilization Co., Ltd., Longyan City, Fujian (CN)

(21) Appl. No.: 14/125,242

(22) PCT Filed: Dec. 30, 2011
(86) PCT No.: PCT/CN2011/084979

§ 371 Date: Mar. 13, 2014

(30) Foreign Application Priority Data
Jun. 10, 2011 (CN) 201110157667.9
Jun. 10, 2011 (CN) 201120197501.5

(51) Int. Cl. B03D 1/02; B03D 1/24

(52) U.S. Cl. CPC B03D 1/02; B03D 1/24
USPC 209/166; 209/170

(57) ABSTRACT

The present invention provides a turbulent flow fly ash flotation process and flotation device. The process of the present invention comprises the following steps: 1) adding a flotation agent and/or a collecting agent to fly ash raw material to form a mixture; 2) in the flotation device, allowing the mixture obtained from step 1) to fall from the upper part of the flotation device; 3) forming upwardly blowing gas in the flotation device, the gas having countercurrent contacts with the falling mixture of step 2), and in the process of the upward movement of the gas, the gas being in a turbulent state; 4) collecting particles which are formed by the upward movement of the gas in step 3) and which pass through the flotation plate of the flotation device. In the present invention, the gas for blowing bubbles and particles upward is in a turbulent state to provide improved flotation effect and higher flotation rate.

### FIELD

The present invention relates to a fly ash flotation process and flotation device, and more particularly, the present invention relates to a flotation process and device by creating turbulent flow of fly ash.

### BACKGROUND

Fly ash is one of the main wastes produced by electricity generating plants, and it contains large amounts of unburned carbon particles, which, after undergoing flotation, can be used as a raw material for manufacturing activated carbon.

A number of fly ash flotation processes and flotation devices have been disclosed in the art. For instance, a flotation process has been disclosed in Chinese patent 200810143173.3 and Chinese patent 99115444, and in Chinese patent 200810031474.7 a flotation column, particularly designed for fly ash flotation, has been disclosed. However, there are some disadvantages in the solutions provided by the art. For example, in the prior art, laminar or cyclonic flow is created by injecting gas into the flotation device to drive the bubbles and the particles, but both laminar flow and cyclonic flow produce poor flotation effect and low flotation rate.

### SUMMARY

To overcome the above disadvantage of the prior art, it is an object of the invention to provide a fly ash flotation process and flotation device in which bubbles and particles in the flotation device are driven by turbulent flow.

As one aspect of the present invention, the present invention provides a fly ash turbulent flow flotation process, comprising the steps of:
1) adding a flotation agent and/or a collecting agent and/or other additives to fly ash raw material, forming a mixture;
2) in the first flotation device, allowing the mixture obtained in step 1) to fall from the upper part of the first flotation device;
3) in the first flotation device, forming upwardly blowing gas, the gas forming countercurrent contacts with the falling mixture of step 2), and during the upward movement of the gas, the gas being in a turbulent state;
4) collecting particles which upwardly pass through the flotation plate of the first flotation device.

In the present invention, the flotation agent used in step 1) can be perpenic oil or C8 aromatics or any other types of flotation agent, and the collecting agent can be light diesel oil or diesel. In fact, adding flotation agent and/or collecting agent is not an essential step, nor is it the key point of the present invention. According to the specific situations of the fly ash, a flotation agent or a collecting agent may not be added. However, to improve flotation efficiency, preferably a small amount of flotation agent and/or collecting agent is added. For example, the amount of the flotation agent and collecting agent added may be 0.1% to 10% of the total weight of the fly ash.

In the present invention, the upwardly blowing gas in step 3) has a pressure greater than atmospheric pressure, preferably a gauge pressure of 1-6 atmospheres, and more preferably 1-2 atmospheres.

In the process provided by the present invention, the main components of fly ash are carbon particles and ash content, hence, after flotation agent and/or collecting agent and/or other additives are added, particles in the fly ash have contacts and collisions with the bubbles, and then carbon particles which are with good flotability adhere to the bubbles, and are carried to rise by the bubbles, thereby achieving flotation, while ash contents which are with poor flotability would sink.

Particularly, since the upwardly blowing gas is in a turbulent state in the present invention, the contacts between carbon particles and bubbles are prolonged. With the contacts being sufficient, the chance of fly ash particles crushed into carbon particles and ash contents is greatly increased, thereby achieving more desirable flotation effect and better flotation efficiency.

In the present invention, the flotation plates of the first flotation device may be a single layer or comprise multi-layers, preferably comprising multi-layers, e.g. 2-5 layers. Particles which upwardly pass through the flotation plates of the first flotation device and are collected in step 4) are particles that pass through the uppermost layer of the flotation plates of the first flotation device.

According to one embodiment of the present invention, the turbulent flow is formed by allowing the gas in the first flotation device to form multiple strands of gas flow in different upward angles. For example, a diffuser can be disposed within the first flotation device. The surface of the diffuser is formed with a plurality of air holes, the plurality of air holes being arranged to face obliquely upward in their respective angles, so that turbulent flow is formed within the first flotation device. On the contrary, in the prior art, a plurality of gas pipes or air holes are in the same direction or angle, the result of which is that swirling flow is formed, and swirling flow is not conducive to desirable flotation, or simply can not fulfill the purpose of the flotation.

According to another embodiment of the present invention, particles which fail to pass upwardly through the flotation plates are conveyed to the mixture-forming vessel of step 1), so that those particles that do not pass upwardly through the flotation plates enter the first flotation device again for another cycle of flotation, thereby enhancing the utilization rate of the raw material. This flotation process is an external circulation. Of course, particles that do not pass upwardly through the flotation plates can also be pumped to the upper part of the first flotation device, so that those particles may, separately or together with the mixture of step 1), fall from the upper part or the top of the first flotation device for further flotation. This flotation process is called internal circulation.

According to still another embodiment of the present invention, a ultrasonic separation means or ultrasonic breakup means is used in the first flotation device to promote the separation of carbon particles from ash contents by means of emitting ultrasonic waves, so that, for example, ultrafine carbon particles with a mesh number of up to 10,000 are formed. Specifically, the ultrasonic separation means or ultrasonic breakup means comprises a ultrasonic wave transmitter and supplementary auxiliary means.

According to another embodiment of the present invention, a reflecting surface is formed in the first flotation device, so that materials in the mixture that fall from the upper part and particles that pass downwardly through the flotation plates have been upward reflected. The reflecting surface may be of various shapes, e.g. a plane shape, a sphere shape or a cone shape with an upward tip.

According to another embodiment of the present invention, downward gas is injected into the mixture to conduce falling of the mixture and to control its falling speed. The gas has a pressure greater than atmospheric pressure, preferably a gauge pressure of 1-6 atmospheres, and more preferably 1-2 atmospheres.

The above process can be called a first stage flotation. Carbon particles obtained in the first stage flotation can be used as raw materials for many purposes, such as the preparation of activated carbon. However, in order to obtain carbon particles of smaller size and greater fineness, carbon particles obtained by the first stage flotation process may undergo a second stage flotation to obtain finer raw materials for, e.g. the preparation of activated carbon. The second stage flotation comprises the following steps:
5) in a second flotation device, allowing the particles obtained in step 4) to fall from the upper part of the second flotation device;
6) forming upwardly blowing gas in the second flotation device, the gas forming countercurrent contacts with particles falling in step 5), and the gas being in a turbulent state during its upward movement.
7) collecting particles which pass through the flotation plate of the second flotation device in step 6).

The flotation device used in steps 1), 2), 3) and 4) is the first flotation device, while the flotation device used in steps 5), 6) and 7) is the second flotation device. The gas in step 6) has a pressure greater than atmospheric pressure, preferably a gauge pressure of 1-6 atmospheres, more preferably 1-2 atmospheres.

According to still another embodiment of the present invention, between steps 4) and 5) there further comprises the following steps: adding a flotation agent and/or a collecting agent and/or other addictives to the particles obtained in step 4), wherein the flotation agent is, for example, perpenic oil or C8 aromatics, and the collecting agent is, for example, light diesel oil or diesel.

Similar to the first flotation device, a reflecting surface is also provided in the second flotation device, so that materials in the mixture that fall from the upper part and particles that pass downwardly through the flotation plate have upward reflections. The reflecting surface may be of various shapes, for example, a plane shape, a sphere shape or a cone shape with an upward tip. In step 5), downward gas is injected into the mixture to conduce falling of the mixture and to control its falling speed. The gas has a pressure greater than atmospheric pressure, preferably a gauge pressure of 1-6 atmospheres, more preferably 1-2 atmospheres.

Also similar to the first flotation device, the flotation plates of the second flotation device may be a single layer or comprise multi-layers, preferably comprising multi-layers, e.g. 2-5 layers. Particles which upwardly pass through the flotation plates of the second flotation device and which are collected in step 4) are particles that pass through the uppermost layer of the flotation plates of the second flotation device.

At the bottom of the first flotation device and the second flotation device, ash contents formed after the flotation are collected.

As another aspect of the present invention, the present invention further provides a fly ash flotation separation device with a turbulent flow diffuser. The flotation separation device comprises a vertically arranged cylinder; an overflow-collection segment on the top of the cylinder; and a tailing-collection segment at the bottom of the cylinder. The overflow-collection segment is provided with a discharge port, and the tailing-collection segment is provided with a tailing outlet. The flotation separation device further comprises:

a diffuser disposed inside the cylinder; the diffuser being formed with a large surface for reflecting bubbles and particles; the diffuser being cone-shaped with an upward tip for enhancing reflectivity of the bubbles and particles; the conical surface of the diffuser being formed with a plurality of air holes; the plurality of air holes being arranged to face obliquely upward in their respective angles, so that turbulent flow is created within cylinder;

spaced multiple-layer flotation plates in the cylinder; the flotation plates being formed with a plurality of holes; the flotation plates having two functions: for stratifying different materials with different floatage, and for limiting the size of bubbles by the diameter of the holes on the flotation plates; the diameter of the holes on the flotation plate being 0.5 cm-5 cm; the flotation plates being made of metal, plastics or other materials, and specifically, the flotation plates comprising 2-30 layers, e.g. two, three or four layers, wherein the bottom layer of the flotation plates is disposed above the diffuser;

a dispensing means disposed at the upper part of the overflow-collection segment; the dispensing means being a vessel which has a plurality of dispensing pipes at its lower part or bottom, the ends of the dispensing pipes being arranged between the diffuser and the bottom layer of the flotation plates;

a gas supply means, the gas supply means being connected with a plurality of holes on the diffuser via a first gas conduit.

The purposes of arranging the cone-shaped diffuser are that: firstly, bubbles containing carbon particles are reflected towards more angles by the cone-shaped diffuser, thereby providing better reflection than a plane reflector; secondly, the diffuser ejects gas, driving the bubbles to diffuse and float in a turbulent state so that better flotation effect is achieved; and thirdly, bubbles that do not pass through the flotation plates are reflected by the cone-shaped diffuser, thereby intensifying the turbulence and improving flotation rate.

Particularly, in the present invention, since the upwardly blowing gas is in a turbulent state, the contacts between carbon particles and bubbles are prolonged. With the contacts being sufficient, the chance of fly ash particles crushed into carbon particles and ash contents is greatly increased, and therefore more desirable flotation effect and better flotation efficiency are achieved.

According to an embodiment of the present invention, in order to achieve a better reflection, the cone angle of the cone-shaped diffuser is 60°-150° (a cone angle is an angle between the two crossed lines of the sectional surface of the thru axis and the conic surface). Different cone angles can be selected for processing different materials; for example, a cone angle of 90° may be selected for processing CFB fly ash.

According to another embodiment of the present invention, the gas supply means is connected to one or more second gas conduits, the second gas conduits leading to the dispensing means or being connected to the dispensing pipes. For example, the second gas conduit can be one conduit leading into the dispensing means; it can also be a plurality of conduits respectively connected to each of the dispensing pipes. In this way, fly ash particles inside the dispensing means are driven and accelerated by the gas to enter the cylinder via the dispensing pipes, thus improving the efficiency of flotation. Compared to the prior art solutions in which materials in the dispensing means are driven to flow the downward by the negative pressure generated in a venturi tube, the present solution conveys high pressure gas by a gas conduit. This solution not only reduces power consumption, but also allows gas pressure to be regulated according to the amount and the viscosity of the materials, thereby improving product fineness.

According to another embodiment of the present invention, the flotation separation device further comprises a physical separation means disposed on the cylindrical wall of the flotation separation device or on the diffuser. By arranging a physical separation means, the bonding between carbon particles and ash contents are effectively disrupted, thereby substantially improving carbon flotation rate. Specifically, the physical separation means can be a ultrasonic separation means or a ultrasonic breakup means to help promote the separation of carbon particles from ash contents by means of emitting ultrasonic waves, so that, for example, ultrafine carbon particles with a mesh number of up to 10,000 are formed. Specifically, the ultrasonic separation means or the ultrasonic breakup means comprises a ultrasonic wave transmitter and supplementary auxiliary means.

According to another embodiment of the present invention, the cylinder comprises a narrower first flotation segment in the upper part of the cylinder and a wider second flotation segment in the lower part of the cylinder. The overflow-collection segment is disposed outside the first flotation segment and the bottom of the overflow-collection segment is below the top of the first flotation segment, for collecting particles overflowed from the flotation segment. For example, the overflow-collection segment may be a cylindrical vessel with holes on its the bottom plate, and the top of the first flotation segment pierces through the holes on the bottom plate of the overflow-collection segment, so that particles which has undergone flotation in the flotation segment continuously stack up to cross the cylindrical wall of the flotation segment and flow into the overflow-collection segment. Another example is that, the external wall of the top of the first flotation segment is provided with overflow holes or overflow pipes, and the overflow-collection segment is a vessel disposed below the overflow holes or overflow pipes. Specifically, between the first flotation segment and the second flotation segment there is disposed with a divergent cone segment as a transitional region, and the divergent cone segment is disposed above the bottom layer of the flotation plates, specifically, between the two layers of the flotation plates, e.g. between the bottom layer of the flotation plates and its adjacent upper layer. By arranging a divergent cone segment, the flotation separation device has bigger reflecting area, allowing bubbles dashing up from below to decelerate and adjust their moving directions. Such an arrangement is advantageous in that, firstly, the turbulent flow of bubbles is intensified by the reflection; and secondly, bubbles are prevented to dash towards the top of the a flotation separation device along the cylinder wall to make the overflow surface on the top uneven.

According to still another embodiment of the present invention, the tailing outlet is connected to a tailing pipe, the tailing pipe directly or indirectly leading to the dispensing means, so that ash tailings re-enter the flotation separation device for further flotation, thereby increasing fly ash flotation rate.

According to another embodiment of the invention, the flotation separation device further comprises a storage means. The lower part or the bottom of the storage means is provided with a feed pipe, the feed pipe leading to the dispensing means. Fly ash for flotation is added with chemicals such as a flotation agent in the storage means, and then enters the dispensing means via the feed pipe disposed at the lower part or the bottom of the material storage means. A stirring unit may be provided inside the storage means for sufficiently stirring the fly ash slurry and the flotation agent. In this embodiment, the tailing pipe can be connected to the storage means. When materials come out of the tailing pipe for further flotation, they are usually added with a chemical such as a flotation agent, and in the dispensing means it is not easy to proceed the action of addition or control the proportion of the addition. Returning to the storage means to proceed this process can effectively solve this problem. Furthermore, a tailing tank may be provided between the tailing outlet and the storage means (for regulating fluid level inside the flotation separation device by the tailings). The tailing pipe is first connected to the tailing tank from the tailing outlet, and then leads to the storage means from the tailing tank. The feed pipe is provided with a slurry pump for pumping the materials inside the storage means into the dispensing means.

According to another embodiment of the present invention, the end of the tailing pipe is disposed above the top layer of the flotation plates, and the end of the tailing pipe is provided with a fluid level adjusting means for adjusting the height of the end of the tailing pipe and in turn adjusting fluid level inside the flotation separation device.

According to another embodiment of the present invention, the cylinder is a round cylinder or square cylinder. A square cylinder may provide reflections at its corners of a square cylinder, while a round cylinder provides more regular distribution of the particles and bubbles. In addition, the upper part of the tailing-collection segment inside the cylinder may be provided with a filter plate to slow down the falling speed of the material.

Compared with the prior art, the upwardly flowing bubbles and particles in the present invention are in a turbulent state, which provides better flotation effect and higher flotation rate.

The present invention will be described with greater detail below with reference to the drawings

### BRIEF DESCRIPTION OF THE DRAWINGS

FIG. 1 is a flow chart of the fly ash flotation process of the present invention;

FIG. 2 is a longitudinal cutaway perspective view of one exemplary embodiment of the flotation separation device for first stage flotation according to the present invention along its central axis; and

FIG. 3 is a longitudinal cutaway perspective view of one exemplary embodiment of a flotation separation device for second stage flotation according to the present invention along its central axis.

### DETAILED DESCRIPTION

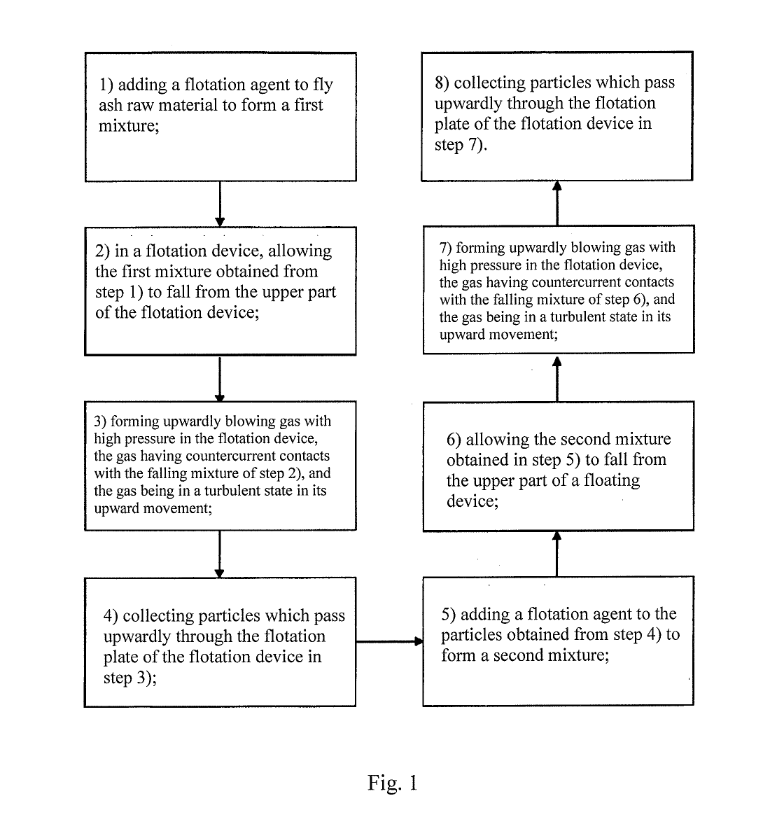

As indicated in FIG. 1, the fly ash flotation process of the present invention comprises the following steps:
1) adding a flotation agent to fly ash raw material to form a first mixture;
2) in the flotation device, allowing the mixture obtained from step 1) to fall from the upper part of the first flotation device;
3) forming upwardly blowing gas in the flotation device, the gas having countercurrent contacts with the falling mixture of step 2), and in the process of its upward movement, the gas being in a turbulent state;
4) collecting particles which pass through the flotation plate of the flotation device;
5) adding a flotation agent to particles obtained from step 4) to form a second mixture;
6) in the flotation device, allowing the mixture obtained from step 5) to fall from the upper part of the flotation device;
7) forming upwardly blowing gas in the flotation device, the gas having countercurrent contacts with the falling mixture of step 6), and in the process of its upward movement, the gas being in a turbulent state;
8) collecting particles which pass through the flotation plates of the flotation device in step 7).

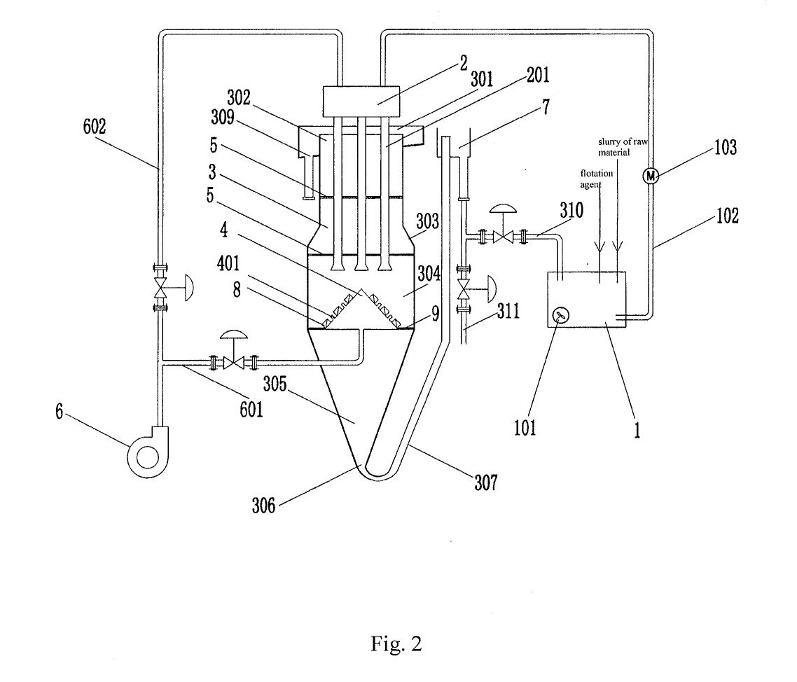

FIG. 2 shows an embodiment of the fly ash flotation separation device for achieving first stage flotation, comprising: a storage means 1, a dispensing means 2, a vertically disposed square cylinder 3, a cone-shaped diffuser 4, multi-layer flotation plates 5, a gas supply means 6, a physical separation means (e.g. ultrasonic separation means) 8, a tailing tank 10 (for regulating fluid level inside the flotation separation device), a filter plate 9, an overflow-collection segment 301, a tailing-collection segment 305.

Vertically disposed square cylinder 3 can be divided into three parts, which, from top to bottom in sequence are: a first flotation segment 302, a divergent cone segment 303, and a second flotation segment 304; wherein first flotation segment 302 is narrower within which a layer of flotation plates 5 is disposed; second flotation segment 304 is wider within which cone-shaped diffuser 4 and a layer of flotation plates 5 are disposed. Between first flotation segment 302 and second flotation segment 304 there is disposed with divergent cone segment 303 which is in the shape of a cone with an upward tip and serves as a transitional region.

Overflow-collection segment 301 is disposed outside first flotation segment 302, and the top of first flotation segment 302 is disposed between the top and the bottom of overflow-collection segment 301. Furthermore, the bottom of the overflow-collection segment 301 is provided with a discharge port 309.

Tailing-collection segment 305 is cone-shaped and has a downward tip, and the tip at its bottom is provided with a tailing outlet 306. Tailing outlet 306 is connected to a tailing pipe 307, and tailing pipe 307 is provided with a slurry pump 308. Between second flotation segment 304 and tailing-collection segment 305, there is provided with filter plate 9.

Diffuser 4 is in the shape of a cone with an upward tip and has a cone angle of about 120°. Its conic surface is formed with a plurality of air holes 401. Diffuser 4 is disposed within second flotation segment 304, and is above cone-shaped tailing-collection segment 305. Diffuser 4 is provided with a plurality of ultrasonic separation means 8.

Spaced multilayer (e.g. two) flotation plates 5 are respectively disposed within first flotation segment 302 and second flotation segment 304, and the bottom layer of flotation plates 5 is above cone-shaped diffuser 4.

Dispensing means 2 is disposed above overflow-collection segment 301, and is a vessel, the lower part of which is provided with a plurality of (e.g. 8) dispensing pipes 201. The ends of dispensing pipes 201 are within second flotation segment 304 and are between cone-shaped diffuser 4 and the bottom layer of flotation plates 5.

A stirring unit 101 is provided within storage means 1 for sufficiently stirring fly ash slurry and flotation agent. Tailing pipe 307 is first connected to tailing tank 10 from tailing outlet 306, and then leads to storage means 1 from tailing tank 10. The lower part of storage means 1 is provided with a feed pipe 102. Feed pipe 102 is provided with a slurry pump 103 and leads to dispensing means 2.

Gas supply means 6 is connected to a first gas conduit 601 and a second gas conduit 602, wherein first gas conduit 601 is connected with the plurality of air holes 401 on cone-shaped diffuser 4, while second gas conduit 602 leads to dispensing means 2.

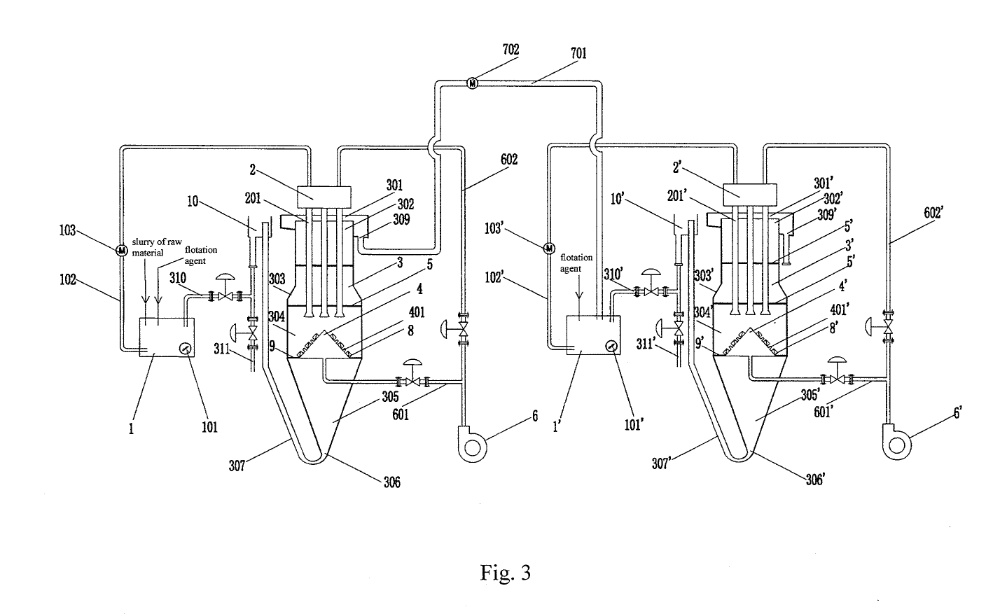

FIG. 3 is an embodiment of a fly ash flotation separation system for achieving second stage flotation, and this flotation separation system further comprises a second stage flotation separation device on the basis of the first stage flotation separation device. The second flotation separation device comprises: a storage means 1′, a dispensing means 2′, a vertically disposed square cylinder 3′, a cone-shaped diffuser 4′, multi-layer flotation plates 5′, a gas supply means 6′, a physical separation means (e.g. ultrasonic separation means) 8′, a filter plate 9′, a tailing tank 10′, an overflow-collection segment 301′, and a tailing-collection segment 305′.

Vertically disposed square cylinder 3′ can be divided into three parts, which, from top to bottom in sequence are: a first flotation segment 302′, a divergent cone segment 303′, and a second flotation segment 304′; wherein first flotation segment 302′ is smaller and a layer of flotation plates 5′ is disposed within first flotation segment 302′, while second flotation segment 304′ is wider and cone-shaped diffuser 4′ and a layer of flotation plates 5′ are disposed within second flotation segment 304′. Between first flotation segment 302′ and second flotation segment 304′ there is disposed with divergent cone segment 303′ which is in the shape of a cone with an upward tip and serves as a transitional region.

Overflow-collection segment 301′ is disposed outside first flotation segment 302′, and the top of first flotation segment 302′ is between the top and the bottom of overflow-collection segment 301′. Furthermore, the bottom of overflow-collection segment 301′ is provided with a discharge port 309′.

Tailing-collection segment 305′ is in the shape of a cone with a downward tip, and the tip at its bottom is provided with a tailing outlet 306′. Tailing outlet 306′ is connected to a tailing pipe 307′, and tailing pipe 307′ is provided with a slurry pump 308′. Between second flotation segment 304′ and tailing-collection segment 305′, there is provided with filter plate 9′.

Diffuser 4′ is in the shape of a cone with an upward tip and has a cone angle of 120°. Its conic surface is formed with a plurality of air holes 401′. Diffuser 4′ is within the second flotation segment 304,′ and is above cone-shaped tailing-collection segment 305′. Diffuser 4′ is provided with a plurality of ultrasonic separation means 8′.

Spaced multilayer (e.g. two) flotation plates 5′ are disposed within first flotation segment 302′ and second flotation segment 304′. The bottom layer of flotation plates 5′ is located above cone-shaped diffuser 4′.

Dispensing means 2′ is disposed above overflow-collection segment 301′, and is a vessel, the lower part of which is provided with a plurality of (e.g. 8) dispensing pipes 201′. The ends of dispensing pipes 201′ are within second flotation segment 304 and are between cone-shaped diffuser 4′ and the bottom layer of flotation plates 5′.

Discharge port 309 of the first flotation separation device is connected to a discharge pipe 701. Discharge pipe 701 is provided with a slurry pump 702. The other end of the discharge pipe 701 is connected to storage means 1′ of the second flotation separation device. A stirring unit 101′ is provided within storage means 1′ for sufficiently stirring fly ash slurry and flotation agent. Tailing pipe 307′ is first connected to tailing tank 10′ from tailing outlet 306′, and then leads to storage means 1′ from tailing tank 10′. The lower part of storage means 1′ is provided with a feed pipe 102′, and feed pipe 102′ is provided with a slurry pump 103′ and leads to dispensing means 2′.

Gas supply means 6′ is connected to first gas conduit 601′ and second gas conduit 602′. First gas conduit 601′ is connected with the plurality of air holes 401′ on cone-shaped diffuser 4′, while second gas conduit 602′ leads to dispensing means 2′.

Although a few preferable embodiments of the present invention have been described in detail above, they are not intended to limit the scope of the embodiments of the present invention. Those skilled in the art will readily appreciate that many modifications are possible in the embodiments without materially departing from the scope of the present invention. Accordingly, all equivalent modifications made according to disclosure of the present application shall be included within the scope of this disclosure.

1. A fly ash flotation process with turbulent flow, comprising the steps of:
1) adding a flotation agent and/or a collecting agent to fly ash raw material to form a mixture;
2) in a first flotation device, allowing the mixture obtained from step 1) to fall from the upper part of the first flotation device;
3) forming upwardly blowing gas in the first flotation device, the gas having countercurrent contacts with the falling mixture of step 2), and the gas being in a turbulent state in its upward movement;
4) collecting particles which are formed by the upward movement of the gas in step 3) and which pass through the flotation plate of said first flotation device.

2. A process of claim 1, wherein said turbulent state of gas is formed by allowing said gas to form a plurality of strands of gas flow in different upward angles in said first flotation device.

3. A process of claim 1, wherein particles which do not go upward to pass through the flotation plate of said first flotation device are conveyed to a vessel which contains the mixture of step 1).

4. A process of claim 1, wherein particles which do not go upward to pass through the flotation plate of said first flotation device are pumped to the upper part of said first flotation device, so that the particles fall from the upper part or the top of said first flotation device separately or together with the mixture obtained from step 1) for further flotation.

5. A process of claim 1, wherein a reflecting surface is arranged in said flotation device, so that materials in mixture that fall from the upper part of said flotation device and particles that pass downwardly through the flotation plate have been upward reflected.

6. A process of claim 1, wherein downward gas is injected into said mixture to conduce falling of said mixture and to control the speed of the falling.

7. A flotation process of claim 1, further comprising the steps of:
5) in a second flotation device, allowing the particles obtained from step 4) to fall from the upper part of the second flotation device;
6) forming upwardly blowing gas in the second flotation device, the gas forming countercurrent contacts with the falling particles of step 5), and the gas being in a turbulent state in the process of its upward movement;
7) collecting particles which are formed in the upward movement of the gas in step 6) and which pass through the flotation plate of said second flotation device.

8. A process of claim 7, wherein between steps 4) and step 5) there further comprises the step of: further adding a flotation agent and/or a collecting agent to the particles obtained from step 4).

9. A process of claim 7, wherein a reflecting surface is arranged in said second flotation device, so that particles that fall from the upper part of said second flotation device and particles that pass downwardly through the flotation plate have upward reflections.

10. A process of claim 7, wherein downward gas is injected into the second mixture to conduce falling of said mixture and to control the speed of the falling.

11. A fly ash flotation separation device with a turbulent flow diffuser, comprising: a vertically disposed cylinder, an overflow-collection segment disposed on the top of the cylinder and a tailing-collection segment disposed at the bottom of the cylinder; said overflow-collection segment being arranged with a discharge port; said tailing-collection segment being arranged with a tailing outlet; wherein said flotation separation device further comprises:
a diffuser disposed in the cylinder; the diffuser being in the shape of a cone with an upward tip, and a plurality of air holes being formed on the conical surface the diffuser;
spaced multiple-layer flotation plates disposed in the cylinder, wherein the bottom layer of the flotation plates is disposed above said diffuser;
a dispensing means disposed in the upper part of said overflow-collection segment, said dispensing means being a vessel which is provided with a plurality of dispensing pipes at its lower part or bottom, the ends of said dispensing pipes being arranged between said diffuser and said bottom layer of the flotation plates;
a gas supply means, said gas supply means being connected to the plurality of air holes on said diffuser via a first gas conduit.

12. A flotation separation device of claim 11, wherein the cone angle of the diffuser is 60°-150°.

13. A flotation separation device of claim 11, wherein said gas supply means is connected to one or more second gas conduits, the second gas conduits leading into said dispensing means or being connected to said dispensing pipes.

14. A flotation separation device of claim 11, wherein said flotation separation device further comprises a physical separation means disposed on the cylindrical wall of said flotation separation device or on said diffuser.

15. A flotation separation device of claim 14, wherein said physical separation means is a ultrasonic separation means.

16. A flotation separation device of claim 11, wherein said cylinder comprises a narrower first flotation segment at the upper part and a wider second flotation segment at the lower part, wherein said overflow-collection segment is disposed outside said first flotation segment and the bottom of said overflow-collection segment is below the top of said first flotation segment.

17. A flotation separation device of claim 16, wherein between said first flotation segment and said second flotation segment there is disposed with a divergent cone segment serving as a transitional region, the divergent cone segment being disposed above the bottom layer of the flotation plates.

18. A flotation separation device of claim 11, wherein said tailing outlet is connected to a tailing pipe, said tailing pipe leading directly or indirectly to said dispensing means.
